(19) United States
(12) Patent Application Publication
(10) Pub. No.: US 2024/0238821 A1
(43) Pub. Date: Jul. 18, 2024

(54) Mask Jig, Film Formation Method, and Film Formation Apparatus

(71) Applicant: TATSUTA ELECTRIC WIRE & CABLE CO., LTD., Osaka (JP)

(72) Inventor: Masaki HIRANO, Kizugawa-shi, Kyoto (JP)

(21) Appl. No.: 18/561,391

(22) PCT Filed: Mar. 30, 2022
(86) PCT No.: PCT/JP2022/016145

§ 371 Date: Nov. 16, 2023

(30) Foreign Application Priority Data
May 31, 2021 (JP) 2021-091375

(51) Int. Cl. B05B 12/20; B05D 1/12; C23C 24/04

(52) U.S. Cl. CPC B05B 12/20; B05D 1/12; C23C 24/04

(57) ABSTRACT

A mask jig, by which a film having stable quality can be efficiently formed on a surface of a substrate, includes a main body portion and a mask cover. The main body portion includes a first surface and a second surface located opposite to the first surface. The mask cover is disposed on the second surface side of the main body portion so as to overlap with the main body portion, and includes a third surface and a fourth surface located opposite to the third surface. The mask cover is composed of an imide-based resin.

### TECHNICAL FIELD

The present disclosure relates to a mask jig, a film formation method, and a film formation apparatus.

### BACKGROUND ART

Conventionally, a cold spraying method, which is one of thermal spraying methods, has been known. In the cold spraying method, a film is formed on a substrate by spraying a film formation material onto the substrate together with a carrier gas (for example, see Japanese Patent Laying-Open No. 2017-170369).

Further, in a thermal spraying method such as the cold spraying method described above, a mask jig disposed on a surface of a substrate is used to define a film formation range (for example, see Japanese Patent Laying-Open No. 2002-361135). By supplying the film formation material to the surface of the substrate via a through hole formed in the mask jig, a planar shape of the film formation region can be defined.

### CITATION LIST

### Patent Literature

PTL 1: Japanese Patent Laying-Open No. 2017-170369
PTL 2: Japanese Patent Laying-Open No. 2002-361135

### SUMMARY OF INVENTION

### Technical Problem

When the mask jig is used in the thermal spraying method such as the cold spraying method described above, a film composed of the film formation material is also formed on a surface of the mask jig. When the film is formed on the surface of the mask jig, a process condition (film formation condition) when supplying the film formation material to the surface of the substrate via the through hole of the mask jig may be accordingly changed from the condition initially set at the start of the film formation. As a result, it becomes difficult to stably form a film on the surface of the substrate. Further, in order to ensure quality of the film formed on the surface of the substrate, a process such as removal of the film formed on the surface of the mask jig needs to be performed whenever a certain time has elapsed. As a result, it is difficult to efficiently form a film having stable quality on the surface of the substrate. In Japanese Patent Laying-Open No. 2002-361135, a measure has been taken to suppress a film from being formed on the surface of the mask jig. However, from the viewpoint of more efficiently forming a film having stable quality on the surface of the substrate, it is preferable to attain further improvement by, for example, manufacturing the mask jig using a material on which a film is less likely to be formed.

It is an object of the present disclosure to provide a mask jig, a film formation method, and a film formation apparatus so as to efficiently form a film having stable quality on a surface of a substrate.

### Solution to Problem

A mask jig according to the present disclosure is used in a thermal spraying method. The mask jig includes a main body portion and a mask cover. The main body portion includes a first surface and a second surface located opposite to the first surface. The mask cover is disposed on the second surface side of the main body portion so as to overlap with the main body portion, and includes a third surface and a fourth surface located opposite to the third surface. The mask cover is composed of an imide-based resin.

A film formation method according to the present disclosure includes disposing the mask jig so as to face a surface of a substrate. In the disposing, the mask jig is disposed such that the first surface of the mask jig faces the surface of the substrate. The film formation method according to the present disclosure includes spraying a powder onto the surface of the substrate via a first through hole and a second through hole of a mask jig in accordance with a cold spraying method, the powder serving as a film formation material.

A film formation apparatus according to the present disclosure includes a spray gun including a nozzle, a powder supply unit, a gas supply unit, and the mask jig. The powder supply unit supplies a powder to the spray gun, the powder serving as a film formation material. The gas supply unit supplies a working gas to the spray gun. The mask jig is disposed between a substrate and the spray gun.

### Advantageous Effects of Invention

According to the above, a film having stable quality can be efficiently formed on a surface of a substrate.

### BRIEF DESCRIPTION OF DRAWINGS

FIG. 1 is a schematic view showing a configuration of a film formation apparatus according to the present embodiment.

FIG. 2 is a schematic cross sectional view showing a mask jig according to the present embodiment as well as a substrate and a base jig on which the mask jig is installed.

FIG. 3 is an enlarged schematic cross sectional view showing a first example of a configuration of a region A enclosed by a dotted line in FIG. 2.

FIG. 4 is an enlarged schematic cross sectional view showing a second example of the configuration of region A enclosed by the dotted line in FIG. 2.

FIG. 5 is an enlarged schematic cross sectional view showing a third example of the configuration of region A enclosed by the dotted line in FIG. 2.

FIG. 6 is an enlarged schematic cross sectional view showing a fourth example of the configuration of region A enclosed by the dotted line in FIG. 2.

FIG. 7 is an enlarged schematic cross sectional view showing a fifth example of the configuration of region A enclosed by the dotted line in FIG. 2.

FIG. 8 is a schematic cross sectional view generally showing a further modification of the mask jig of FIG. 2.

FIG. 9 is a flowchart showing a film formation method according to the present embodiment.

FIG. 10 is a schematic cross sectional view showing a first example of a configuration of a mask jig used in an Example 3.

FIG. 11 is a schematic cross sectional view showing a second example of the configuration of the mask jig used in Example 3.

FIG. 12 is a schematic cross sectional view showing a third example of the configuration of the mask jig used in Example 3.

FIG. 13 shows a photograph showing a manner of adhesion of a film formation material on an inner wall of an inclined portion formed in a main body portion of a sample 11 of Example 3 when viewed from above.

FIG. 14 shows a photograph showing a manner of adhesion of a film formation material on an inner wall of an inclined portion formed in a main body portion of a sample 12 of Example 3 when viewed from above.

FIG. 15 shows a photograph showing a manner of adhesion of a film formation material on an inner wall of an inclined portion formed in a main body portion of a sample 13 of Example 3 when viewed from above.

### DESCRIPTION OF EMBODIMENTS

Hereinafter, embodiments of the present disclosure will be described. It should be noted that the same configurations are denoted by the same reference characters and will not be described repeatedly.

### <Configuration of Film Formation Apparatus>

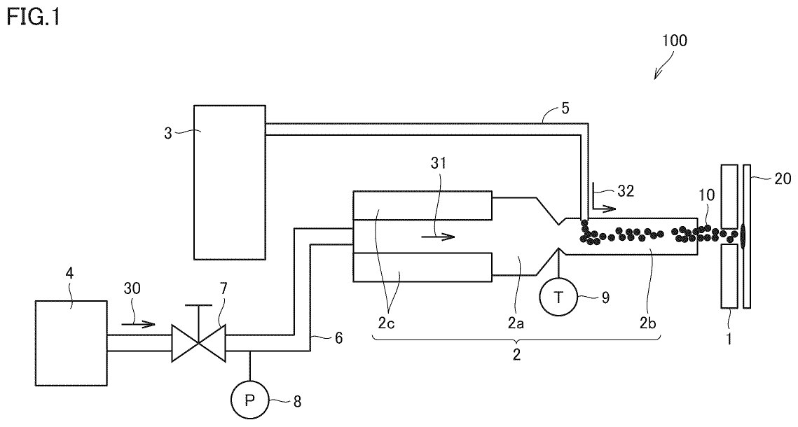

FIG. 1 is a schematic view showing a configuration of a film formation apparatus according to the present embodiment. Referring to FIG. 1, a film formation apparatus 100 mainly includes a spray gun 2 including a nozzle 2b, a powder supply unit 3, a gas supply unit 4, and a mask jig 1.

Spray gun 2 mainly includes a spray gun main body portion 2a, nozzle 2b, a heater 2c, and a temperature sensor 9. Nozzle 2b is connected to a first end, i.e., front end side, of spray gun main body portion 2a. A pipe 6 is connected to a second end, i.e., rear end side, of spray gun main body portion 2a. Pipe 6 is connected to gas supply unit 4 via a valve 7. Gas supply unit 4 supplies a working gas to spray gun 2 via pipe 6. By opening and closing valve 7, a supply state of the working gas from gas supply unit 4 to spray gun 2 can be controlled. A pressure sensor 8 is installed at pipe 6. Pressure sensor 8 measures pressure of the working gas supplied from gas supply unit 4 to pipe 6.

The working gas supplied from the second end of spray gun main body portion 2a to the inside of spray gun main body portion 2a is heated by heater 2c. Heater 2c is disposed on the second end side of spray gun main body portion 2a. The working gas flows inside spray gun main body portion 2a along an arrow 31. Temperature sensor 9 is connected to a connection portion between nozzle 2b and spray gun main body portion 2a. Temperature sensor 9 measures the temperature of the working gas flowing inside spray gun main body portion 2a.

A pipe 5 is connected to nozzle 2b. Pipe 5 is connected to powder supply unit 3. Powder supply unit 3 supplies a powder to nozzle 2b of spray gun 2 via pipe 5, the powder serving as a film formation material.

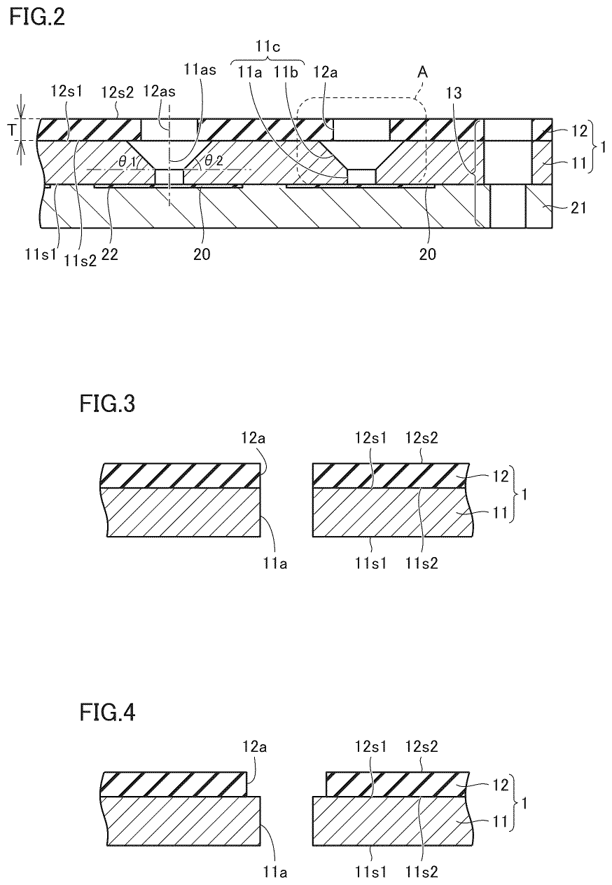

Mask jig 1 is disposed between a substrate 20 and spray gun 2. Mask jig 1 is provided with a first through hole 11c and a second through hole 12a (see FIG. 2). First through hole 11c and second through hole 12a define a film formation region on a surface of substrate 20. A specific configuration of mask jig 1 will be described later.

### <Operation of Film Formation Apparatus>

In film formation apparatus 100 shown in FIG. 1, the working gas is supplied from gas supply unit 4 to spray gun 2 via pipe 6 as indicated by an arrow 30. Examples of the working gas usable herein include nitrogen, helium, dry air, or a mixture thereof. The pressure of the working gas is, for example, about 1 MPa. The flow rate of the working gas is, for example, 300 L/minute or more and 500 L/minute or less. The working gas supplied to the second end of spray gun main body portion 2a is heated by heater 2c. The heating temperature for the working gas is appropriately set in accordance with a composition of the film formation material, and may be, for example, 100° C. or more and 500° C. or less. The working gas flows from spray gun main body portion 2a to nozzle 2b. Powder 10 serving as the film formation material is supplied from powder supply unit 3 to nozzle 2b via pipe 5 as indicated by an arrow 32. Examples of powder 10 usable herein include a nickel powder, a tin powder, or a mixed material of a tin powder and a zinc powder. Alternatively, for example, an aluminum powder may be used as the powder. The particle diameter of powder 10 is, for example, 1 μm or more and 50 μm or less.

Powder 10 supplied to nozzle 2b is sprayed from the front end of nozzle 2b toward substrate 20 together with the working gas. Mask jig 1 is disposed on the surface of substrate 20. Sprayed powder 10 reaches the surface of substrate 20 via first through hole 11c and second through hole 12a (see FIG. 2) of mask jig 1. A film made from sprayed powder 10 is formed on the surface of substrate 20.

### <Configuration of Mask Jig>

FIG. 2 is a schematic cross sectional view showing the mask jig according to the present embodiment as well as the substrate and a base jig on which the mask jig is installed. Referring to FIG. 2, mask jig 1 is used in the cold spraying method, which is one example of the thermal spraying method. Mask jig 1 includes a main body portion 11 and a mask cover 12.

Main body portion 11 includes a first surface 11s1 and a second surface 11s2. Second surface 11s2 is located opposite to first surface 11s1. Each of first surface 11s1 and second surface 11s2 has a quadrangular shape, for example. A distance from first surface 11s1 to second surface 11s2, i.e., the thickness of main body portion 11, is substantially unchanged in the whole of main body portion 11. Therefore, main body portion 11 is a plate-shaped member having a quadrangular planar shape.

Mask cover 12 includes a third surface 12s1 and a fourth surface 12s2. Fourth surface 12s2 is located opposite to third surface 12s1. Each of third surface 12s1 and fourth surface 12s2 has a quadrangular shape, for example. A distance from third surface 12s1 to fourth surface 12s2, i.e., thickness T of mask cover 12, is substantially unchanged in the whole of mask cover 12. Therefore, mask cover 12 is a plate-shaped member having a quadrangular planar shape. Mask cover 12 is disposed on the second surface 11s2 side of main body portion 11, i.e., on the upper side in FIG. 2, so as to overlap with main body portion 11. Mask cover 12 is disposed such that third surface 12s1 and second surface 11s2 of main body portion 11 face each other and are in contact with each other.

Mask cover 12 is composed of an imide-based resin. Specifically, mask cover 12 is composed of polyamideimide, for example. It should be noted that mask cover 12 may be composed of, for example, polyimide instead of polyamideimide.

Main body portion 11 is provided with first through hole 11c. First through hole 11c extends from first surface 11s1 through main body portion 11 to reach second surface 11s2. First through hole 11c may have any planar shape such as a circular shape or a quadrangular shape (particularly, a square shape) when viewed in a plan view.

First through hole 11c is a portion in which the member constituting main body portion 11 is absent, and may have a columnar portion 11a and an inclined portion 11b. An inner wall of columnar portion 11a extends in a direction substantially orthogonal to first surface 11s1 and second surface 11s2 as a whole. That is, in the cross sectional view of FIG. 2, two portions of the inner wall of columnar portion 11a, which are disposed at positions deviated by 180° from each other with respect to the center and face each other, extend in parallel with each other. Therefore, the inner wall of columnar portion 11a at the left end and the inner wall of columnar portion 11a at the right end in the cross sectional view of FIG. 2 are parallel to each other. It should be noted that the expression “direction substantially orthogonal” herein permits an error of ±1° or less with respect to an exact right angle direction. The inner wall of inclined portion 11b extends in a direction inclined with respect to the direction substantially orthogonal to first surface 11s1 and second surface 11s2. That is, in the cross sectional view of FIG. 2, each of the inner wall of inclined portion 11b at the left end and the inner wall of inclined portion 11b at the right end extends in a direction different from the inner wall of columnar portion 11a. Each of the inner wall of inclined portion 11b at the left end and the inner wall of inclined portion 11b at the right end extends in a direction inclined with respect to first surface 11s1 and second surface 11s2.

As shown in FIG. 2, inclined portion 11b is preferably formed on the second surface 11s2 side with respect to columnar portion 11a, and the inner wall thereof is preferably inclined to have a diameter gradually increased from the first surface 11s1 side toward the second surface 11s2 side. However, it is not limited thereto, and for example, inclined portion 11b may be formed on the first surface 11s1 side with respect to columnar portion 11a. The inner wall of inclined portion 11b may be inclined to have a diameter gradually decreased from the first surface 11s1 side toward the second surface 11s2 side. Alternatively, for example, inclined portion 11b may be formed only at the central portion in a direction connecting first surface 11s1 and second surface 11s2 together without making contact with each of first surface 11s1 and second surface 11s2. In this case, columnar portion 11a reaching first surface 11s1 is formed on the first surface 11s1 side of inclined portion 11b, and columnar portion 11a reaching first surface 11s1 is formed on the first surface 11s1 side of inclined portion 11b. Preferably, the inner wall of columnar portion 11a and the inner wall of inclined portion 11b are continuous to each other at a boundary between columnar portion 11a and inclined portion 11b adjacent to each other.

It should be noted that in FIG. 2, as an example, first through hole 11c has both columnar portion 11a and inclined portion 11b. However, it is not limited thereto, and first through hole 11c may only have columnar portion 11a or may only have inclined portion 11b. Further, when the planar shape of first through hole 11c or the like is circular, the diameter of first through hole 11c or the like is the diameter of the circular shape. However, when the planar shape of first through hole 11c or the like is a square shape, the diameter is the length of one side of the square shape.

Mask cover 12 is provided with second through hole 12a. Second through hole 12a extends from third surface 12s1 through mask cover 12 to reach fourth surface 12s2. As with columnar portion 11a, the inner wall of second through hole 12a extends in the direction substantially orthogonal to first surface 11s1 and second surface 11s2 as a whole. However, as with inclined portion 11b, the inner wall of second through hole 12a may extend in a direction inclined with respect to a direction substantially orthogonal to third surface 12s1 and fourth surface 12s2. The inclination angle of the inner wall of second through hole 12a with respect to the direction orthogonal to third surface 12s1 may be, for example, 10° or less with respect to the direction orthogonal to third surface 12s1.

Although not shown, each of first through hole 11c and second through hole 12a does not extend across the whole of mask jig 1 in a length direction in the plane of sheet of FIG. 2, and is formed only in part of a region in the length direction in the plane of sheet of FIG. 2. That is, the size of each of first through hole 11c and second through hole 12a in the length direction in the plane of sheet of FIG. 2 is relatively short. Specifically, the size of each of first through hole 11c and second through hole 12a in the length direction in the plane of sheet of FIG. 2 is equal to the size thereof in the leftward/rightward direction of FIG. 2 or is slightly larger or smaller than the size thereof in the leftward/rightward direction.

Base jig 21 is a member for installing substrate 20 thereon, substrate 20 being a target on which a film is to be formed. Base jig 21 is a plate-shaped member having a quadrangular planar shape. Base jig 21 may be installed such that one main surface side thereof, i.e., the main surface thereof on the upper side in FIG. 2 may be in contact with first surface 11s1 of main body portion 11 of mask jig 1 as shown in FIG. 2. However, as shown in FIG. 1, base jig 21 may be installed such that the one main surface thereof may not be in contact with first surface 11s1 (with a space being interposed between base jig 21 and first surface 11s1).

A groove portion 22 is formed in the main surface of base jig 21 facing first surface 11s1. Groove portion 22 is formed in a portion of the one main surface of base jig 21 as a recess recessed in a direction orthogonal to the main surface. By inserting substrate 20 into groove portion 22, substrate 20 is installed on base jig 21.

A screwing hole 13 is formed to extend through each of mask cover 12, main body portion 11, and base jig 21, which are stacked in contact with one another. Screwing hole 13 is formed such that all the holes formed in mask cover 12, main body portion 11, and base jig 21 overlap with one another when viewed in a plan view. In this way, mask cover 12 can be fixed to main body portion 11 and base jig 21 by screwing. Therefore, each of mask cover 12 and main body portion 11 can be replaced individually. As a result, when the life of mask cover 12 is different from the life of main body portion 11, cost at the time of replacement can be reduced as compared with a configuration in which main body portion 11 and mask cover 12 are in one piece.

As shown in FIG. 2, the diameter of screwing hole 13 in base jig 21 may be smaller than the diameter of screwing hole 13 in each of mask cover 12 and main body portion 11, and the diameter of screwing hole 13 in mask cover 12 may be the same as the diameter of screwing hole 13 in main body portion 11. However, the diameter of screwing hole 13 in main body portion 11 may be the same as the diameter of screwing hole 13 in base jig 21, and the diameter of screwing hole 13 in mask cover 12 may be larger than the diameter of screwing hole 13 in main body portion 11.

Next, each of materials, sizes, and the like of the above-described members will be described. For main body portion 11 of mask jig 1, any material can be employed; however, copper, which is a metal material having a high heat dissipation property, may be used, for example. Thus, a thermal influence on substrate 20 can be reduced. However, a metal such as stainless steel or steel, carbon, or a ceramic such as alumina can be applied as main body portion 11 instead of copper, for example.

In main body portion 11, a thin film may be formed on the surface of the copper, for example. The thin film is preferably composed of a material having a low affinity with a material of the film to be formed using mask jig 1, for example. That is, for example, when mask jig 1 is used for aluminum film formation by the thermal spraying method, a thin film of, for example, tin, which is a material having a low affinity with aluminum (material that is less likely to come into contact with aluminum; material that is less likely to be mixed with aluminum; material that is less likely to be bonded to aluminum), is preferably formed on the surface of main body portion 11 composed of copper.

Particularly, each of minimum angles θ1, 02 between each of first surface 11s1 and second surface 11s2 and the inner wall of inclined portion 11b of first through hole 11c formed in main body portion 11 is preferably 30° or more and 60° or less. That is, each of angles θ1 and 02 between an alternate long and short dash line parallel to each of first surface 11s1 and the like and the inner wall of inclined portion 11b in FIG. 2 is preferably 30° or more and 60° or less. Angles θ1 and θ2 may be the same or different from each other. The inner wall may partially include a curved surface. Further, each of inclination angles θ1 and θ2 may be unchanged in the whole of the inner wall; however, the inner wall may include a surface having inclination angles θ1 and θ2 that are locally different.

Preferably, thickness T of mask cover 12 of mask jig 1, i.e., distance between third surface 12s1 and fourth surface 12s2, is 0.5 mm or more and 2.0 mm or less. Base jig 21 is preferably composed of a metal material having a high heat dissipation property. Specifically, base jig 21 is preferably composed of one of a copper-based metal material and an aluminum-based metal material. It should be noted that the thickness of main body portion 11, i.e., distance between first surface 11s1 and second surface 11s2, is preferably 1.5 mm or more and 3 mm or less. In mask jig 1, mask cover 12 is preferably thinner than main body portion 11. However, it is not limited thereto, and main body portion 11 and mask cover 12 may have the same thickness. Alternatively, mask cover 12 may be thicker than main body portion 11.

The diameter of second through hole 12a is equal to or more than the diameter of first through hole 11c. The expression “equal to or more than” includes both a case where one value is equal to the other value and a case where one value is more (larger) than the other value. That is, the diameter of second through hole 12a may be the same as the diameter of first through hole 11c or may be larger than the diameter of first through hole 11c. It should be noted that when the diameter of second through hole 12a is larger than the diameter of first through hole 11c, a second central axis 12as passing through the center of second through hole 12a when viewed in a plan view may be present on the same straight line as a first central axis 11as passing through the center of first through hole 11c when viewed in a plan view. That is, as shown in FIG. 2, second central axis 12as and first central axis 11as may overlap with each other so as to be coaxial. Alternatively, although not shown, for example, first central axis 11as in FIG. 2 may be disposed at a position displaced to the right side or to the left side with respect to second central axis 12as, and they may be therefore axes located at different positions. Here, a magnitude relation between the diameters of first through hole 11c and second through hole 12a will be described with conceivable modifications.

FIG. 3 is an enlarged schematic cross sectional view showing a first example of the configuration of a region A enclosed by a dotted line in FIG. 2. Referring to FIG. 3, in the first example, the first through hole of main body portion 11 is constituted only of columnar portion 11a and has an unchanged diameter as a whole. As with columnar portion 11a, the diameter of second through hole 12a of mask cover 12 is unchanged as a whole. The diameter of columnar portion 11a is equal to the diameter of second through hole 12a. Such a configuration may also be employed.

FIG. 4 is an enlarged schematic cross sectional view showing a second example of the configuration of region A enclosed by the dotted line in FIG. 2. Referring to FIG. 4, in the second example, as with the first example, the first through hole of main body portion 11 is constituted only of columnar portion 11a, and as with columnar portion 11a, the diameter of second through hole 12a of mask cover 12 is unchanged as a whole. The diameter of second through hole 12a is larger than the diameter of columnar portion 11a. In the second example of FIG. 4, the case where the diameter of columnar portion 11a and the diameter of second through hole 12a are equal to each other as in FIG. 3 is excluded. Such a configuration may also be employed.

FIG. 5 is an enlarged schematic cross sectional view showing a third example of the configuration of region A enclosed by the dotted line in FIG. 2. Referring to FIG. 5, in the third example, the first through hole of main body portion 11 is constituted only of inclined portion 11b. The inner wall of inclined portion 11b is inclined with respect to the direction orthogonal to first surface 11s1 and second surface 11s2 so as to have a diameter gradually increased from the first surface 11s1 side toward the second surface 11s2 side. A maximum diameter D1 of inclined portion 11b, which is the maximum value of the diameter of inclined portion 11b when viewed in a plan view, is formed on second surface 11s2, and a minimum diameter D2 of inclined portion 11b, which is the minimum value of the diameter of inclined portion 11b when viewed in a plan view, is formed on first surface 11s1. On the other hand, as with columnar portion 11a, a diameter D3 of second through hole 12a of mask cover 12 is unchanged as a whole. Diameter D3 of second through hole 12a is larger than minimum diameter D2 of inclined portion 11b and is smaller than maximum diameter D1 of inclined portion 11b. Such a configuration may also be employed.

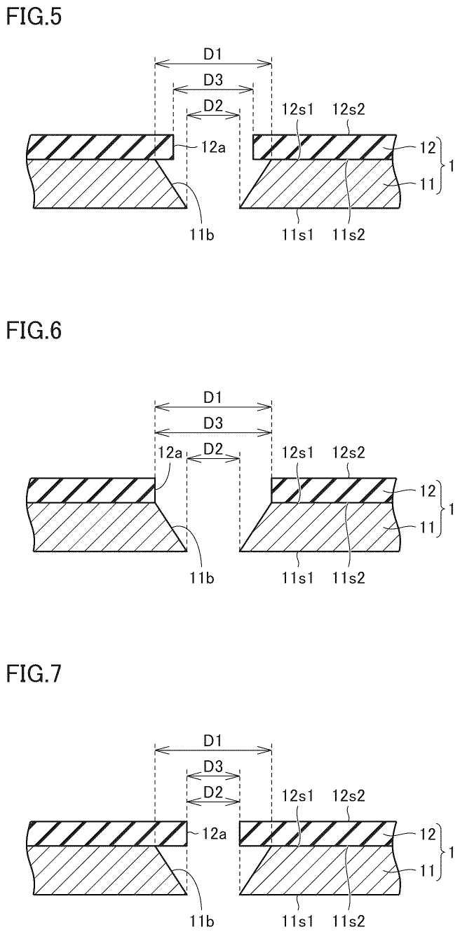

FIG. 6 is an enlarged schematic cross sectional view showing a fourth example of the configuration of region A enclosed by the dotted line in FIG. 2. Referring to FIG. 6, in the fourth example, as with the third example, the first through hole of main body portion 11 is constituted only of inclined portion 11b, and the inner wall thereof is inclined to have a diameter gradually increased from the first surface 11s1 side toward the second surface 11s2 side. Diameter D3 of second through hole 12a of mask cover 12 is unchanged as a whole. Diameter D3 of second through hole 12a is larger than minimum diameter D2 of inclined portion 11b and is equal to maximum diameter D1 of inclined portion 11b. Such a configuration may also be employed.

FIG. 7 is an enlarged schematic cross sectional view showing a fifth example of the configuration of region A enclosed by the dotted line in FIG. 2. Referring to FIG. 6, in the fifth example, the shapes of the first through hole and second through hole 12a are the same as those in the third example and the fourth example, and therefore will not be described repeatedly. Diameter D3 of second through hole 12a is equal to minimum diameter D2 of inclined portion 11b and is smaller than maximum diameter D1 of inclined portion 11b. Such a configuration may also be employed.

It should be noted that although not shown, if second through hole 12a of mask cover 12 only has an inclined portion having an inclined inner wall (or has an inclined portion at its part as described below) as with inclined portion 11b of first through hole 11c, the diameter of second through hole 12a is considered as the minimum value in the above description.

### <Further Modification>

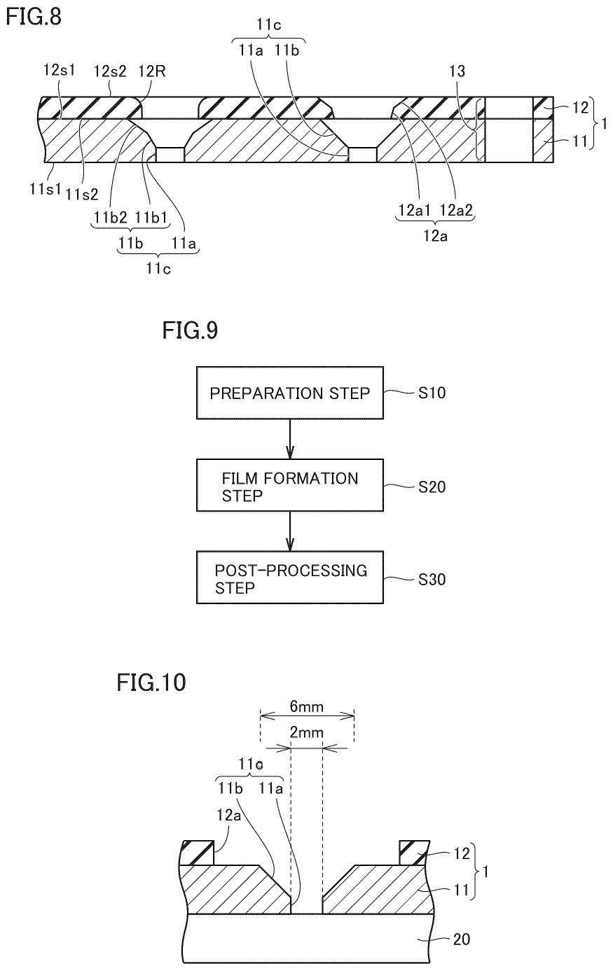

FIG. 8 is a schematic cross sectional view generally showing a further modification of the mask jig of FIG. 2. Second through hole 12a of mask cover 12 may be formed to intersect (be orthogonal to) an end portion intersecting fourth surface 12s2 as shown in FIG. 2. However, referring to FIG. 8, second through hole 12a may be formed to be rounded in the form of, for example, a portion (curved surface) of a spherical surface at the end portion intersecting fourth surface 12s2. That is, in the cross sectional view of FIG. 8, the portion at which second through hole 12a and fourth surface 12s2 intersect may be a curved surface 12R having a curved shape (for example, a circular arc shape or a shape of a portion of an ellipse). The same applies to the end portion at which second through hole 12a and third surface 12s1 intersect.

When second through hole 12a of mask cover 12 extends in a direction inclined with respect to the direction orthogonal to third surface 12s1 or the like, the inclination angle of the inclined portion may be formed to be changed in two or more stages. That is, the inner wall of second through hole 12a may be formed to have two or more inclined portions having inclination angles different from each other. As an example, in FIG. 8, the inner wall of second through hole 12a includes two inclined portions 12a1 and 12a2 having different angles with respect to third surface 12s1.

The same applies not only to mask cover 12 but also to main body portion 11. The inner wall of inclined portion 11b of main body portion 11 may also be formed to have an inclination angle changed in two or more stages. As an example, a portion of inclined portion 11b shown in FIG. 8 includes two inclined portions 11b1 and 11b2 having different angles with respect to first surface 11s1. Further, an end portion of first through hole 11c that intersects at least one of first surface 11s1 and second surface 11s2 may be formed to be rounded in the form of a curved surface (curved shape in the cross sectional view of FIG. 8).

### <Functions and Effects>

Mask jig 1 according to the present disclosure is used in the thermal spraying method. Mask jig 1 includes main body portion 11 and mask cover 12. Main body portion 11 includes first surface 11s1 and second surface 11s2 located opposite to first surface 11s1. Mask cover 12 is disposed on the second surface 11s2 side of main body portion 11 so as to overlap with main body portion 11. Mask cover 12 includes third surface 12s1 and fourth surface 12s2 located opposite to third surface 12s1. Mask cover 12 is composed of an imide-based resin.

The material of the film formed by the thermal spraying method is less likely to be formed on the surface of mask cover 12 composed of the imide-based resin that is a resin material having high heat resistance. Therefore, in the case where powder 10 (see FIG. 1) of the material used for the film formation is supplied from the mask cover 12 side, when the substrate or the like on which the film is to be formed is disposed on the downstream side of the powder with respect to mask jig 1, the film can be suppressed from being formed on the surface of mask jig 1 on which the film should not be formed. Further, mask cover 12 is disposed on the second surface 11s2 side of main body portion 11 so as to overlap with main body portion 11 (so as to cover the surface of main body portion 11), thereby suppressing the film from being formed on the surface of main body portion 11. Therefore, the film formation condition can be suppressed from being changed from the condition initially set at the start of the film formation. Thus, a film having stable quality can be formed on the surface of the substrate more efficiently than in the case of performing a surface treatment onto the formed mask as a post-treatment, for example.

In mask jig 1, first through hole 11c is formed in main body portion 11 to extend from first surface 11s1 to reach second surface 11s2. Second through hole 12a is formed in mask cover 12 to extend from third surface 12s1 to reach fourth surface 12s2. The diameter of second through hole 12a is equal to or more than the diameter of first through hole 11c. Such a configuration may also be employed. The diameter of second through hole 12a may be more than the diameter of first through hole 11c.

A region of the surface of the substrate on which the film is to be formed is defined by first through hole 11c formed in main body portion 11 adjacent to the substrate. This is because the film is formed on a region overlapping with the region in which first through hole 11c is formed. Since the diameter of second through hole 12a is equal to or more than the diameter of first through hole 11c (more than the diameter of first through hole 11c), the region which is located inside first through hole 11c of main body portion 11 and on which the film is to be formed is suppressed from being covered with a region of mask cover 12 other than the through hole, thereby suppressing inhibition of the film formation. In addition to the stabilization of the film quality by mask cover 12 and the increased efficiency of the film formation, it is possible to suppress such a problem that the film cannot be formed due to mask cover 12 closing part of first through hole 11c. That is, with the through holes formed in mask jig 1, mask jig 1 can maintain the function as a mask.

Further, when the diameter of second through hole 12a is more than the diameter of first through hole 11c, the following effect can be obtained. When the number of times of forming films is increased, the region of mask cover 12 adjacent to second through hole 12a may be deformed by heat during use, thereby distorting the shape of second through hole 12a. Even in such a case, when the diameter of second through hole 12a is more than the diameter of first through hole 11c, the region which is located inside first through hole 11c of main body portion 11 and on which the film is to be formed does not overlap with the region other than the through hole of mask cover 12. This is due to the following reason: since second through hole 12a is large, a margin for avoiding mask cover 12 from closing a portion inside first through hole 11c is formed even when mask cover 12 is deformed. Therefore, the function of mask jig 1 including mask cover 12 as a mask can be maintained.

In mask jig 1, first through hole 11c is formed in main body portion 11 to extend from first surface 11s1 to reach second surface 11s2. Second through hole 12a is formed in mask cover 12 to extend from third surface 12s1 to reach fourth surface 12s2. The inner wall of first through hole 11c extends in the direction inclined with respect to the direction orthogonal to first surface 11s1 and second surface 11s2. Diameter D3 of second through hole 12a is equal to or more than minimum diameter D2 of first through hole 11c and equal to or less than maximum diameter D1 of first through hole 11c. Such a configuration may also be employed.

The region of the surface of the substrate on which the film is to be formed is defined by minimum diameter D2 of first through hole 11c formed in main body portion 11 adjacent to the substrate. This is because the film is formed on the region overlapping with the inside of minimum diameter D2 of first through hole 11c. Even when diameter D3 of second through hole 12a is minimum, diameter D3 of second through hole 12a is the same in size as minimum diameter D2 of first through hole 11c. Therefore, the region which is located inside first through hole 11c of main body portion 11 and on which the film is to be formed is suppressed from overlapping with the region of mask cover 12 other than second through hole 12a. Therefore, in addition to the stabilization of the quality of the film by mask cover 12 and the increased efficiency of the film formation, it is possible to suppress such a problem that part of the inside of first through hole 11c is closed by mask cover 12 and the film cannot be formed through the closed part. That is, with the through holes formed in mask jig 1, mask jig 1 can maintain the function as a mask.

Powder 10 (see FIG. 1) passing through second through hole 12a of mask cover 12 may be adhered to the inner wall of second through hole 12a. Here, in mask jig 1, the inner wall of first through hole 11c has inclined portion 11b. Therefore, as compared with the case where the inner wall is not inclined with respect to the direction orthogonal to first surface 11s1, collision energy when powder 10 (see FIG. 1) passing through second through hole 12a of mask cover 12 collides with the inner wall of first through hole 11c can be reduced. Therefore, the film can be suppressed from being formed on the edge, i.e., the inner wall of the through hole of mask jig 1.

In mask jig 1, the minimum angle between the inner wall of first through hole 11c and each of first surface 11s1 and second surface 11s2 may be 30° or more and 60° or less. Thus, as described above, the collision energy when powder 10 (see FIG. 1) passing through second through hole 12a of mask cover 12 collides with the inner wall of first through hole 11c can be reduced. Therefore, the film can be suppressed from being formed on the edge, i.e., the inner wall of the through hole of mask jig 1.

In mask jig 1, the thickness of mask cover 12 may be 0.5 mm or more and 2.0 mm or less from the viewpoint of improving the above-mentioned functions and effects.

### <Film Formation Method>

FIG. 9 is a flowchart showing a film formation method according to the present embodiment. Referring to FIG. 9, the film formation method according to the present embodiment is a film formation method performed using mask jig 1 and film formation apparatus 100 shown in FIGS. 1 to 7, and mainly includes a preparation step (S10), a film formation step (S20), and a post-processing step (S30).

The preparation step (S10) includes a step of disposing mask jig 1 to face the surface of substrate 20 as shown in FIG. 1. In the step of disposing, mask jig 1 is disposed such that first surface 11s1 (see FIGS. 2 to 7) of mask jig 1 faces the surface of substrate 20. As described above, main body portion 11 of mask jig 1 is preferably composed of a material having a low affinity with the material of the powder to be sprayed in the next film formation step (S20).

In the film formation step (S20), the powder serving as the film formation material is sprayed onto the surface of substrate 20 by the cold spraying method using film formation apparatus 100 via first through hole 11c and second through hole 12a (see FIG. 2) of mask jig 1. As a result, the film composed of the film formation material is formed on the surface of substrate 20.

In the post-processing step (S30), mask jig 1 is removed from the surface of substrate 20. After that, a necessary process such as machining of substrate 20 is performed. In this way, the film can be formed on the surface of substrate 20.

In the above-described film formation method, since mask jig 1 according to the present embodiment is used, an amount of adhesion of the film formation material to mask jig 1 can be reduced, thereby attaining a long period of time during which the film formation step (S20) can be continuously performed. Alternatively, by using mask jig 1, the number of times in which mask jig 1 can be repeatedly used can be increased.

Hereinafter, each example for confirming the effects of the mask jig according to the present disclosure will be described.

### Example 1

### <Samples>

The amount of adhesion of the film formation material to the surface of main body portion 11 was investigated when a mask jig having no mask cover 12 and constituted only of main body portion 11 was disposed to face the surface of substrate 20 as shown in FIGS. 1 and 2 and film formation was performed using film formation apparatus 100 shown in FIG. 1. It should be noted that first through hole 11c of main body portion 11 used was constituted only of inclined portion 11b, and each of angles θ1, θ2 (see FIG. 2) with first surface 11s1 was 45°. Samples of mask jigs each constituted only of such a main body portion 11 and composed of different materials were prepared. Specifically, a sample 1 composed of stainless steel SUS304, a sample 2 composed of carbon steel, and a sample 3 composed of copper were prepared. Each of the samples had a quadrangular planar shape, and had a size of 42 mm in width×30 mm in length×3 mm in thickness. The maximum diameter of inclined portion 11b was 6 mm and the minimum diameter thereof was 2 mm. First through holes 11c are formed in the form of a matrix such that two first through holes 11c are provided with a space being interposed therebetween in a longitudinal direction (short-side direction) and three first through holes 11c are provided with a space being provided therebetween in a lateral direction (long-side direction) orthogonal to the longitudinal direction when viewed in a plan view.

### <Film Formation Process and Results>

Each of samples 1 to 3 was used to form a film on the surface of the substrate by the cold spraying method. Aluminum powder was used as the film formation material. The aluminum powder had a spherical shape and a diameter of 10 μm. The material of substrate 20 was alumina (Al₂O₃). The shape of substrate 20 is a plate shape having a quadrangular planar shape. The size of the substrate was 42 mm in width×30 mm in length×3 mm in thickness.

As the film formation conditions, dry air was used as the working gas, the temperature of the working gas was 270° C., the flow rate of the working gas was 400 liters/minute, and the pressure of the working gas was about 0.7 MPa. The width (nozzle width) of the region via which the film formation material was sprayed from the film formation apparatus to the surface of the mask jig was 5 mm. Further, a speed (sweeping speed) at which the region via which the film formation material was sprayed was moved to include the region in which the through hole was formed in the surface of the mask jig was 5 mm/second. The size of the film formation range on the surface of the mask jig (region via which the film formation material was sprayed) was 5 mm in width×30 mm in length. In each sample, the film formation material was sprayed five times to the film formation range, thereby forming the film on the surface of the substrate.

While forming the film on the substrate surface using each of samples 1 to 3 under the above-described conditions, the amount of adhesion (mg/pass) of the film formation material for each one time of spraying and the amount of adhesion (mg) of the film formation material after five times of spraying were measured in the region onto which the film formation material for each of samples 1 to 3 was sprayed. Results are shown in Table 1 below.

TABLE 1

| | Main Body Portion 11 Having | | |
|---|---|---|---|
| | Inclined Portion 11b | | |
| | SUS304 | Carbon Steel | Copper |
| | (Sample 1) | (Sample 2) | (Sample 3) |
| One Time of Spraying | 12.2 | 11.2 | 7.7 |
| (mg/pass) | | | |
| Five Times of Spraying | 52.4 | 40.7 | 30.7 |
| (mg) | | | |

In view of Table 1, when the material of main body portion 11 is copper as in sample 3, the amount of adhesion of the film formation material can be reduced as compared with the other materials. In other words, when a material having a high thermal conductivity is used for main body portion 11 (mask jig), the amount of adhesion of the film formation material can be reduced as compared with the case where a material having a low thermal conductivity is used.

Next, copper was used as the material of main body portion 11, and a thin film of a material having a low affinity with the film formation material was formed (surface-treated) on the surface of main body portion 11, and then the same measurement as described above was performed. Specifically, a sample 4 was prepared in which a thin film of tin having a low affinity with aluminum serving as the film formation material was formed by plating on a surface of the same sample as sample 3. Further, a sample 5 was prepared in which a thin film of chromium was formed by plating on a surface of the same sample as sample 3. Table 2 below shows a comparison between the result of sample 3 in Table 1 and a measurement result of each of samples 4 and 5.

TABLE 2

| | Copper Main Body Portion 11 | | |
|---|---|---|---|
| | Having Inclined Portion 11b | | |
| | No Plating | Sn Plating | Cr Plating |
| | (Sample 3) | (Sample 4) | (Sample 5) |
| One Time of Spraying | 7.7 | 6.1 | 10.6 |
| (mg/pass) | | | |
| Five Times of Spraying | 30.7 | 19.0 | 30.7 |
| (mg) | | | |

In view of Table 2, in sample 4 in which the thin film of tin having a low affinity with aluminum serving as the film formation material was formed on the surface, the amount of adhesion of the film formation material could be reduced as compared with samples 3 and 5.

### Example 2

### <Samples>

By using the sample of the mask jig constituted only of main body portion 11 and having no mask cover as in Example 1 and the sample of mask jig 1 including main body portion 11 and mask cover 12 as in the present embodiment, the amounts of adhesion of the film formation material to the columnar portions formed in the main body portions of the mask jigs were compared when the film formation was performed by film formation apparatus 100 shown in FIG. 1. Specifically, a sample 6 was prepared which is composed of stainless steel SUS304 as in sample 1 of Example 1 and which is constituted only of main body portion 11 having the same configuration as in FIGS. 3 and 4 with first through hole 11c being constituted only of columnar portion 11a. Further, a sample 10 including the same main body portion 11 as that of sample 6 and mask cover 12 provided thereon was prepared. Mask cover 12 prepared to form mask jig 1 of sample 10 was composed of polyamideimide. Mask cover 12 was provided with second through hole 12a extending in the direction orthogonal to third surface 12s1 (see FIG. 2). The thickness of mask cover 12 was 1.5 mm and the diameter of second through hole 12a was 5 mm. Second through hole 12a is formed at a position of mask cover 12 overlapping with first through hole 11c when viewed in a plan view.

### <Film Formation Process>

Each of sample 6 and sample 10 described above was used to form a film on the substrate surface by the cold spraying method. Aluminum powder was used as the film formation material. The aluminum powder had a spherical shape and a diameter of 10 μm. The material of substrate 20 was stainless steel (SUS304). The shape and size of substrate 20 were the same as those in Example 1.

As the film formation conditions, dry air was used as the working gas, the temperature of the working gas was 270° C., the flow rate of the working gas was 400 liters/minute, and the pressure of the working gas was about 0.7 MPa. The nozzle width was 5 mm. The sweeping speed was 10 mm/second. The size of the film formation range was 5 mm in width×30 mm in length. In each sample, a region on which the film formation material was sprayed only one time in the film formation range was formed.

While forming the film on the substrate surface using each of samples 11 to 13 under the above-described conditions, the weight (amount of adhesion) of the film formation material adhered to the surface of the inner wall of columnar portion 11a of main body portion 11 of each of samples 6 and 10 was measured and observed. Results are shown in Table 3 below.

TABLE 3

Main Body Portion 11 Having
Columnar Portion 11a

| | Only SUS304 | With Cover |
|---|---|---|
| | (Sample 6) | (Sample 10) |
| One Time of Spraying | 24.8 | −3.2 |
| (mg/pass) | | |
| Five Times of Spraying | 112.7 | −14.0 |
| (mg) | | |

In Table 3, a stacking amount in sample 10 having mask cover 12 composed of polyamideimide is a negative value, and this indicates that the film formation material was not adhered at all. In view of Table 3, when the material of main body portion 11 is stainless steel SUS304, the adhesion of the film formation material to mask jig 1 was suppressed by covering it with mask cover 12 composed of the imide-based resin having heat resistance.

### Example 3

### <Samples>

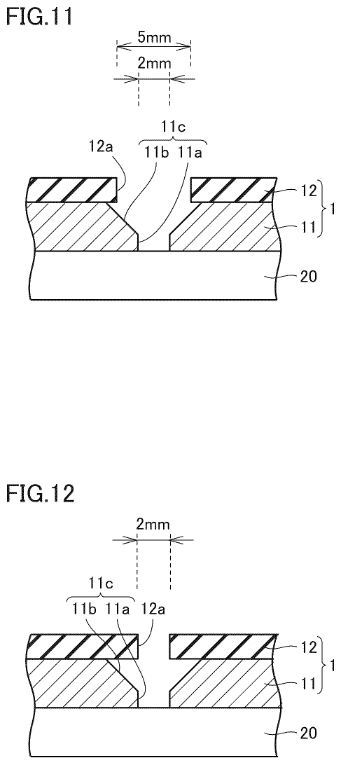

FIG. 10 is a schematic cross sectional view showing a first example of a configuration of a mask jig used in an Example 3. FIG. 11 is a schematic cross sectional view showing a second example of the configuration of the mask jig used in Example 3. FIG. 12 is a schematic cross sectional view showing a third example of the configuration of the mask jig used in Example 3. Referring to FIGS. 10 to 12, a sample 11 of mask jig 1 having the configuration shown in FIG. 10, a sample 12 of mask jig 1 having the configuration shown in FIG. 11, and a sample 13 of mask jig 1 having the configuration shown in FIG. 12 were prepared.

Specifically, each of sample 11 shown in FIG. 10, sample 12 shown in FIG. 11, and sample 13 shown in FIG. 12 has generally the same shape as that of mask jig 1 shown in FIG. 2. That is, first through hole 11c of main body portion 11 has both columnar portion 11a and inclined portion 11b, and second through hole 12a of mask cover 12 extends in the direction orthogonal to first surface 11s1 and the like (see FIG. 2). The diameter of columnar portion 11a was 2 mm, and the maximum diameter of inclined portion 11b was 6 mm. The thickness of mask cover 12 was 1.5 mm. It should be noted that main body portion 11 is composed of copper and mask cover 12 is composed of polyamideimide.

As sample 11 of FIG. 10, sample 12 of FIG. 11, and sample 13 of FIG. 12, samples of mask jigs 1 provided with second through holes 12a having different diameters were prepared. Specifically, in sample 11 of FIG. 10, the diameter of second through hole 12a was the largest, and was sufficiently larger than the maximum diameter of inclined portion 11b. In sample 12 of FIG. 11, the diameter of second through hole 12a was slightly smaller than the maximum diameter of inclined portion 11b, and was sufficiently larger than the minimum diameter of inclined portion 11b. Specifically, in sample 12 of FIG. 11, the diameter of second through hole 12a was 5 mm. In sample 13 of FIG. 12, the diameter of second through hole 12a was about the same as the minimum diameter of inclined portion 11b. Specifically, in sample 13 of FIG. 12, the diameter of second through hole 12a was 2 mm. That is, FIG. 11 is directed to the configuration similar to that of FIG. 5 or 6, and FIG. 12 is directed to the configuration similar to that of FIG. 7. FIG. 10 is not similar to any of FIGS. 3 to 7.

### <Film Formation Process>

Each of samples 11 to 13 was used to form a film on the substrate surface by the cold spraying method. Aluminum powder was used as the film formation material. The aluminum powder had a spherical shape and a diameter of 10 μm. The material of substrate 20 was stainless steel (SUS304). The shape and size of substrate 20 were the same as those in Example 1.

As the film formation conditions, dry air was used as the working gas, the temperature of the working gas was 270° C., the flow rate of the working gas was 400 liters/minute, and the pressure of the working gas was about 0.7 MPa. The nozzle width was 5 mm. The sweeping speed was 5 mm/second. The size of the film formation range was 5 mm in width×30 mm in length. In each sample, a region on which the film formation material was sprayed only one time in the film formation range was formed.

After forming the film on the surface of the substrate using each of samples 11 to 13 under the above-described conditions, the weight (amount of adhesion) of the film formation material adhered to the surface of the inner wall of inclined portion 11b of main body portion 11 of each of samples 11 to 13 was measured and observed.

### <Results>

Amount of Adhesion on Inner Wall of Inclined Portion 11b in Each Sample:

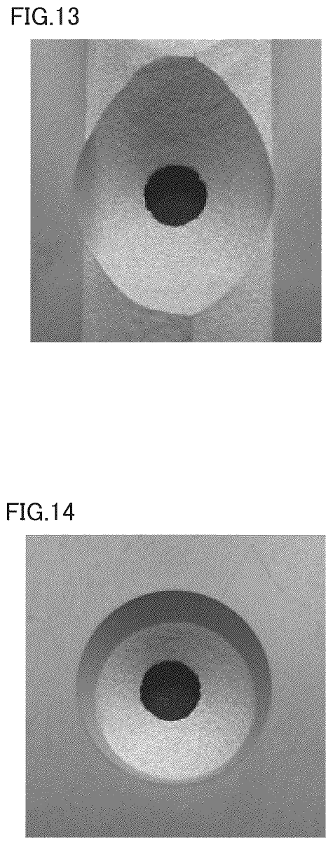

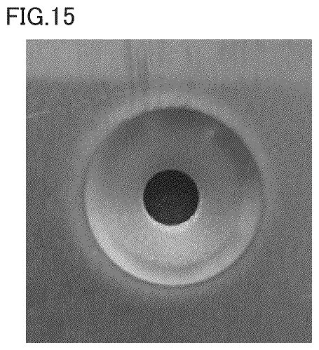

FIG. 13 shows a photograph showing a manner of adhesion of the film formation material on the inner wall of the inclined portion formed in the main body portion of sample 11 of Example 3 when viewed from above. FIG. 14 shows a photograph showing a manner of adhesion of the film formation material on the inner wall of the inclined portion formed in the main body portion of sample 12 of Example 3 when viewed from above. FIG. 15 shows a photograph showing a manner of adhesion of the film formation material on the inner wall of the inclined portion formed in the main body portion of sample 13 of Example 3 when viewed from above. Referring to FIGS. 13 to 15, the amount of adhesion in sample 11 was 80 mg. On the other hand, no adhesion took place in each of samples 12 and 13. As a result, it was indicated that the amount of adhesion of the film formation material was reduced in the mask jig according to the present disclosure (particularly those provided with the through holes having the sizes as shown in FIGS. 5 and 7).

The embodiments disclosed herein are illustrative and non-restrictive in any respect. At least two of the embodiments disclosed herein may be combined unless contradicted. The basic scope of the present disclosure is defined by the terms of the claims, rather than the embodiments described above, and is intended to include any modifications within the scope and meaning equivalent to the terms of the claims.

### REFERENCE SIGNS LIST

1: mask jig; 2: spray gun; 2a: spray gun main body portion; 2b: nozzle; 2c: heater; 3: powder supply unit; 4: gas supply unit; 5, 6: pipe; 7: valve; 8: pressure sensor; 9: temperature sensor; 10: powder; 11: main body portion; 11a: columnar portion; 11as: first central axis; 11b, 11b1, 11b2, 12a1, 12a2: inclined portion; 11c: first through hole; 11s1: first surface; 11s2: second surface; 12: mask cover; 12a: second through hole; 12as: second central axis; 12R: curved surface; 12s1: third surface; 12s2: fourth surface; 13: screwing hole; 20: substrate; 21: base jig; 22: groove portion; 100: film formation apparatus.

1. A mask jig used in a thermal spraying method, the mask jig comprising:
a main body portion including a first surface and a second surface located opposite to the first surface; and
a mask cover disposed on the second surface side of the main body portion so as to overlap with the main body portion, the mask cover including a third surface and a fourth surface located opposite to the third surface, wherein
the mask cover is composed of an imide-based resin.

2. The mask jig according to claim 1, wherein
the main body portion is provided with a first through hole extending from the first surface to reach the second surface,
the mask cover is provided with a second through hole extending from the third surface to reach the fourth surface, and
a diameter of the second through hole is equal to or more than a diameter of the first through hole.

3. The mask jig according to claim 2, wherein the diameter of the second through hole is more than the diameter of the first through hole.

4. The mask jig according to claim 1, wherein
the main body portion is provided with a first through hole extending from the first surface to reach the second surface,
the mask cover is provided with a second through hole extending from the third surface to reach the fourth surface,
an inner wall of the first through hole extends in a direction inclined with respect to a direction orthogonal to the first surface and the second surface, and
a diameter of the second through hole is equal to or more than a minimum diameter of the first through hole and is equal to or less than a maximum diameter of the first through hole.

5. The mask jig according to claim 4, wherein a minimum angle between the inner wall and each of the first surface and the second surface is 30° or more and 60° or less.

6. The mask jig according to claim 1, wherein a thickness of the mask cover is 0.5 mm or more and 2.0 mm or less.

7. A film formation method comprising disposing the mask jig according to claim 1 so as to face a surface of a substrate, wherein
in the disposing, the mask jig is disposed such that the first surface of the mask jig faces the surface of the substrate,
the film formation method further comprising spraying a powder onto the surface of the substrate via a first through hole and a second through hole of the mask jig in accordance with a cold spraying method, the powder serving as a film formation material.

8. A film formation apparatus comprising:
a spray gun including a nozzle;
a powder supply unit that supplies a powder to the spray gun, the powder serving as a film formation material;
a gas supply unit that supplies a working gas to the spray gun; and
the mask jig according to claim 1, the mask jig being disposed between a substrate and the spray gun.
